(19) United States
(12) Patent Application Publication
(10) Pub. No.: US 2011/0277461 A1
(43) Pub. Date: Nov. 17, 2011

(54) ACTIVE MATERIAL-BASED CLAMP AND RELEASE DEVICE

(75) Inventors: Alan L. Browne, Grosse Pointe, MI (US); Nancy L. Johnson, Northville, MI (US); Paul W. Alexander, Ypsilanti, MI (US); Roland J. Menassa, Macomb, MI (US); James W. Wells, Rochester Hills, MI (US)

(73) Assignee: GM GLOBAL TECHNOLOGY OPERATIONS, INC., Detroit, MI (US)

(21) Appl. No.: 12/779,952

(22) Filed: May 13, 2010

(51) Int. Cl. F03G 7/06

(52) U.S. Cl. 60/527

(57) ABSTRACT

An active material-based device for and related method of clamping and releasing objects. Broadly, the device includes an elongated piece of active material, such as a wire, having an actuation temperature and arranged to form a sleeve defining a volume of space. When the active material reaches the actuation temperature the material changes, which causes one or more dimensions of the volume of space to change. An object located within the sleeve experiences either a clamping or releasing force resulting from the change in the volume of space.

### BACKGROUND OF THE INVENTION

1. Technical Field

This disclosure generally relates to devices for clamping and releasing objects, and, more particularly, to active material-based devices for and related methods of clamping and releasing objects.

2. Background Art

A device for clamping and releasing an object typically uses first and second opposed surfaces, or “jaws”, to exert a force on the object. It will be appreciated that such a device suffers from a number of limitations. For example, the device, unless specifically designed for use on a particular object, cannot conform to an object with an irregular shape. Furthermore, the device flattens the object by applying the force over the limited surface area of the two jaws, which can deform or weaken the object. Additionally, the device is limited to actuation by mechanical or electrical signals; if another type of actuation signal is desired, then a transducer must be included to transform the actuation signal to a mechanical or electrical signal. Additionally, the device may be relatively large and heavy, depending on the particular application and the level of required force, and relatively complex and expensive to manufacture, operate, and maintain.

### BRIEF SUMMARY

The present invention provides an active material-based device for and related method of clamping and releasing objects. Broadly, the device comprises an elongated piece of active material having an actuation temperature, with the active material being arranged to form a sleeve defining a volume of space, wherein when the active material reaches the actuation temperature the material changes, which causes the dimensions (length versus diameter) of the volume of space to change. The elongated piece of active material may have any suitable form, such as, e.g., wires, cables, sheets, or strips. Furthermore, the elongated piece of active material may have any suitable arrangement, such as, e.g., spirally wrapped, woven, braided, single layered, multilayered, looped, or banded.

In one exemplary embodiment, the device may comprise a wire, the wire being formed from an active material having an actuation temperature and a dimension, and the wire being arranged to form the sleeve defining the volume of space, wherein when the wire reaches the actuation temperature its dimension changes, which causes the dimensions of the volume of space to change in a way that either applies or removes a force on an object located within the space.

In various configurations of this embodiment, any one or more of the following features may be incorporated into the device. The wire may be configured such that reaching the actuation temperature causes the volume of space to become smaller, or constrict around the object located within the space. This may be accomplished, for example, by arranging the wire in a spiral form with an angle that is at least approximately 55 degrees. The wire may be configured such that reaching the actuation temperature causes the volume of space to become larger, or loosen around the object located within the space. This may be accomplished, for example, by arranging the wire in a spiral form with an angle of less than approximately 55 degrees. The change in dimension may be reversible by changing the temperature, depending on the particular active material used. The (first) wire may be arranged in a spiral form with a first angle, with the device further comprising a second wire having a second actuation temperature and a second angle, such that the (first) wire and the second wire are separately actuatable to cause different changes to the dimensions of the volume of space.

For example, the device may comprise the first wire formed from an active material having a first actuation temperature and a first dimension, and the first wire being arranged to form the sleeve defining a volume of space, wherein when the first wire reaches its actuation temperature the first dimension changes, which causes a first force on the volume of space; and the second wire formed from an active material having a second actuation temperature and a second dimension, and the second wire being arranged to form the sleeve defining the volume of space, wherein when the second wire reaches its actuation temperature the second dimension changes, which causes a second force on the volume of space.

It will be appreciated that the device of the present invention provides a number of advantages over conventional clamping and releasing devices. For example, the device of the present invention readily conforms to objects with irregular shapes. Furthermore, the force applied by the device to an object located within the sleeve is relatively uniformly distributed around the object and over a relatively large surface area, which better avoids deforming or weakening the object. Additionally, the device is directly actuatable by any signal that warms or cools the device to the actuation temperature, without requiring a separate transducer. Additionally, the device is relatively small and lightweight, and relatively simple and inexpensive to manufacture, operate, and maintain.

Other aspects and advantages of the present invention are discussed in the following detailed description of the preferred embodiment(s) and depicted in the accompanying drawing figures.

### BRIEF DESCRIPTION OF THE SEVERAL VIEWS OF THE DRAWING

A preferred embodiment(s) of the invention is described in detail below with reference to the attached drawing figures, wherein:

FIG. 1 is a perspective view of the device of the present invention, wherein the device is shown in a first state;

FIG. 2 is a perspective view of the device of FIG. 1 shown in a second state resulting from application of an actuation signal;

FIG. 3 is a sectional perspective view of an exemplary embodiment of the device showing various features;

FIG. 4 is a perspective view of an exemplary configuration of the device showing various features;

FIG. 5 is a perspective view of an exemplary configuration of the device adapted for supporting a joint;

FIG. 6 is a sectional perspective view of an exemplary configuration of the device showing various features;

FIG. 7 is a cross-sectional elevation view of an exemplary configuration of the device adapted for pumping, wherein the device is shown in a first state;

FIG. 8 is a cross-sectional elevation view of the device of FIG. 7 shown in a second state resulting from application of an actuation signal;

FIG. 9 is a sectional perspective view of an exemplary configuration of the device adapted for use as an internal braking mechanism;

FIG. 10 is a cross-sectional elevation view of an exemplary configuration of the device adapted for moving a pin or other object, wherein the device is shown in a first state;

FIG. 11 is a cross-sectional elevation view of the device of FIG. 10 shown in a second state resulting from application of an actuation signal; and

FIG. 12 is an elevation view of an exemplary configuration of the device adapted for moving or moving along a cable or other object, wherein a plurality of the devices are actuated sequentially.

### DETAILED DESCRIPTION

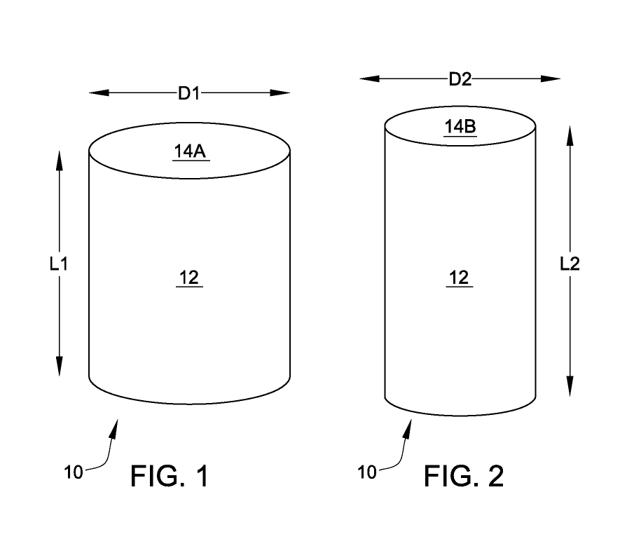

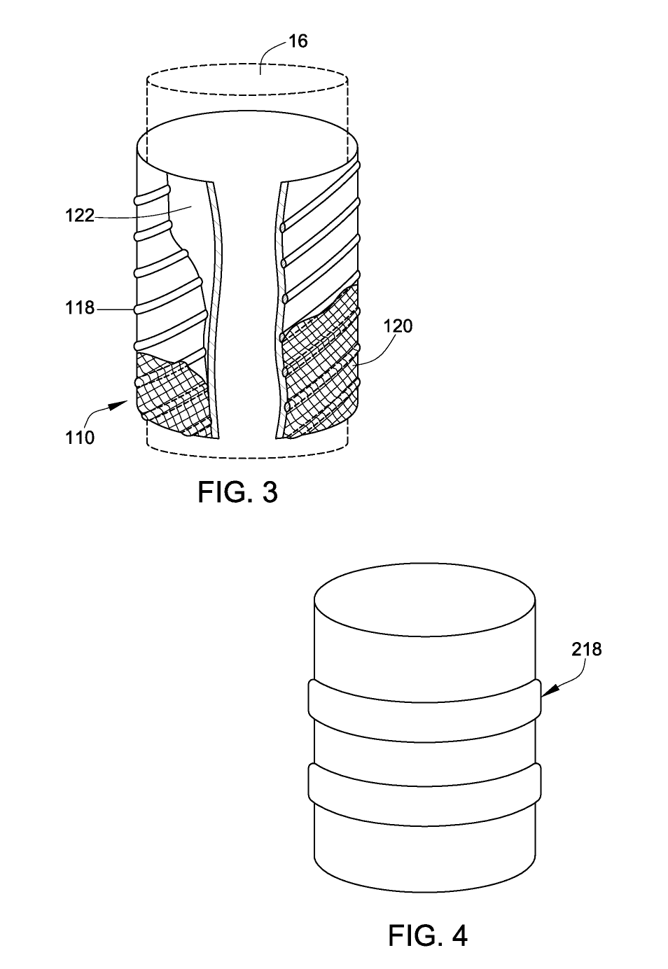

The present invention provides an active material-based device for and related method of clamping and releasing objects. As shown in FIG. 1, the device 10 broadly comprises an elongated piece of active material having an actuation temperature, with the active material being arranged to form a sleeve 12 defining a volume of space 14A, wherein when the active material reaches the actuation temperature the material changes, which causes the dimensions (shape, but not necessarily volume) of the volume of space 14A to change (compare FIGS. 1 and 2). More specifically, in a first state, seen in FIG. 1, the sleeve 12 has first dimensions, such as a first length L1 and a first diameter D1, which define the volume of space 14A, and in a second state, seen in FIG. 2, the sleeve 12 has second dimensions, such as a second length L2 and a second diameter D2, which redefine the volume of space 14B, wherein the change from the first state to the second state results from application of an actuation signal to the device 10, i.e., the active material reaches the actuation temperature. As shown in FIG. 3, an object 16 located within the sleeve 12 experiences either a clamping or releasing force resulting from the change in the volume of space 14A,14B. The elongated piece of active material may have any suitable form, such as that of a wire, cable, sheet, or strip. Furthermore, the elongated piece of active material may have any suitable arrangement, such as spirally wrapped, woven, braided, single layered, multilayered, looped, or banded. As shown in FIG. 4, for example, the active material may take the form of loops or bands 218.

Although various exemplary embodiments, configurations, and implementations are depicted and described herein, the device 10 of the present invention may be adapted for use in many different applications involving clamping (i.e., applying force to) or releasing (i.e., removing force from) objects. Relatedly, although depicted herein as being substantially cylindrical, the object 16 may have any of a variety of cross-sectional shapes or other dimensions, including complex shapes.

I. Active Material Discussion and Function

As used herein the term “active material” shall be afforded its ordinary meaning as understood by those of ordinary skill in the art, and includes any material or composite that exhibits a change in a fundamental (e.g., chemical or intrinsic physical) property when exposed to an activation signal. Thus, active materials shall include those compositions that can exhibit a change in, e.g., stiffness, shape, or dimension in response to the activation signal, which can take the type, for different active materials, of electrical, magnetic, thermal and like fields.

Suitable active materials for use with the present invention include but are not limited to shape memory materials such as shape memory alloys and shape memory polymers. Shape memory materials generally refer to materials or compositions that have the ability to remember at least one original attribute such as shape, which can subsequently be recalled by applying the actuation signal. As such, deformation from the original shape is reversible. In this manner, shape memory materials can change to the original, or “trained”, shape in response to the activation signal. Exemplary active materials include the aforementioned shape memory alloys (SMA) and shape memory polymers (SMP), as well as shape memory ceramics, electroactive polymers (EAP), ferromagnetic SMA's, electrorheological (ER) compositions, magnetorheological (MR) compositions, dielectric elastomers, ionic polymer metal composites (IPMC), piezoelectric polymers, piezoelectric ceramics, various combinations of the foregoing materials, and the like.

Shape memory alloys generally refer to a group of metallic materials that demonstrate the ability to return to some previously defined shape or size when subjected to an appropriate thermal stimulus. Shape memory alloys are capable of undergoing phase transitions in which their yield strength, stiffness, dimension, or shape are altered as a function of temperature. The term “yield strength” refers to the stress at which a material exhibits a specified deviation from proportionality of stress and strain. Generally, in the low temperature, or martensite phase, shape memory alloys can be plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

Shape memory alloys exist in several different temperature-dependent phases. The most commonly utilized of these phases are the so-called martensite and austenite phases discussed above. In the following discussion, the martensite phase generally refers to the more deformable, lower temperature phase, whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal of sufficient magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the shape.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above-discussed phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of several degrees and the start or finish of the transformation can be controlled to within a degree or two depending on the desired application and alloy composition. The mechanical properties of the shape memory alloy vary greatly over the temperature range spanning their transformation, typically providing the system with shape memory effects, superelastic effects, and high damping capacity.

Suitable shape memory alloy materials include, without limitation, nickel-titanium-based alloys, indium-titanium-based alloys, nickel-aluminum-based alloys, nickel-gallium-based alloys, copper-based alloys (e.g., copper-zinc alloys, copper-aluminum alloys, copper-gold, and copper-tin alloys), gold-cadmium-based alloys, silver-cadmium-based alloys, indium-cadmium-based alloys, manganese-copper-based alloys, iron-platinum-based alloys, iron-platinum-based alloys, iron-palladium-based alloys, and the like. The alloys can be binary, ternary, or any higher order so long as the alloy composition exhibits a shape memory effect, e.g., change in shape orientation, damping capacity, and the like.

Ferromagnetic SMA's (FSMA's) are a sub-class of SMAs. These materials behave like conventional SMA materials that have a stress or thermally induced phase transformation between martensite and austenite. Additionally FSMA's are ferromagnetic and have strong magnetocrystalline anisotropy, which permit an external magnetic field to influence the orientation/fraction of field aligned martensitic variants. When the magnetic field is removed, the material may exhibit complete two-way, partial two-way or one-way shape memory. For partial or one-way shape memory, an external stimulus, temperature, magnetic field or stress may permit the material to return to its starting state. External magnetic fields may, for example, be produced using soft-magnetic core electromagnets, especially in automotive applications; alternatively, a pair of Helmholtz coils may be used for fast response.

Shape memory polymers (SMP's) generally refer to a group of polymeric materials that demonstrate the ability to return to a previously defined shape when subjected to an appropriate thermal stimulus. Shape memory polymers are capable of undergoing phase transitions in which their shape is altered as a function of temperature. Generally, SMP's have two main segments: a hard segment and a soft segment. The previously defined or permanent shape can be set by melting or processing the polymer at a temperature higher than the highest thermal transition followed by cooling below that thermal transition temperature. The highest thermal transition is usually the glass transition temperature (T_{g}) or melting point of the hard segment. A temporary shape can be set by heating the material to a temperature higher than the T_{g} or the transition temperature of the soft segment, but lower than the T_{g} or melting point of the hard segment. The temporary shape is set while processing the material at the transition temperature of the soft segment followed by cooling to fix the shape. The material can be reverted back to the permanent shape by heating the material above the transition temperature of the soft segment.

For example, the permanent shape of the polymeric material may be a wire presenting a substantially straight shape and defining a first length and a first diameter, while the temporary shape may be a similar wire defining a second length less than the first length and a second diameter greater than the first diameter. In another embodiment, the material may present a spring having a first modulus of elasticity when activated and second modulus when deactivated. The temperature required for return to the original shape will depend on the particular material and the particular application.

Suitable shape memory polymers include thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acids), polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

Suitable piezoelectric materials include, but are not limited to, inorganic compounds, organic compounds, and metals. With regard to organic materials, all of the polymeric materials with non-centrosymmetric structure and large dipole moment group(s) on the main chain or on the side-chain, or on both chains within the molecules, can be used as suitable candidates for the piezoelectric film. Exemplary polymers include, for example, but are not limited to, poly(sodium 4-styrenesulfonate), poly (poly(vinylamine)backbone azo chromophore), and their derivatives; polyfluorocarbons, including polyvinylidenefluoride, its co-polymer vinylidene fluoride (“VDF”), co-trifluoroethylene, and their derivatives; polychlorocarbons, including poly(vinyl chloride), polyvinylidene chloride, and their derivatives; polyacrylonitriles, and their derivatives; polycarboxylic acids, including poly(methacrylic acid), and their derivatives; polyureas, and their derivatives; polyurethanes, and their derivatives; bio-molecules such as poly-L-lactic acids and their derivatives, and cell membrane proteins, as well as phosphate bio-molecules such as phosphodilipids; polyanilines and their derivatives, and all of the derivatives of tetramines; polyamides including aromatic polyamides and polyimides, including Kapton® and polyetherimide, and their derivatives; all of the membrane polymers; poly(N-vinyl pyrrolidone) (PVP) homopolymer, and its derivatives, and random PVP-co-vinyl acetate copolymers; and all of the aromatic polymers with dipole moment groups in the main-chain or side-chains, or in both the main-chain and the side-chains, and mixtures thereof.

Piezoelectric materials can also comprise metals selected from the group consisting of lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals. Suitable metal oxides include SiO₂, Al₂O₃, ZrO₂, TiO₂, SrTiO₃, PbTiO₃, BaTiO₃, FeO₃, Fe₃O₄, ZnO, and mixtures thereof and Group VIA and IIB compounds, such as CdSe, CdS, GaAs, AgCaSe₂, ZnSe, GaP, InP, ZnS, and mixtures thereof.

Electroactive polymers include those polymeric materials that exhibit piezoelectric, pyroelectric, or electrostrictive properties in response to electrical or mechanical fields. Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, such as, for example, polymer blends comprising a silicone elastomer and an acrylic elastomer.

Materials used as an electroactive polymer may be selected based on one or more material properties such as a high electrical breakdown strength, a low modulus of elasticity (for large or small deformations), a high dielectric constant, and the like. Electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present invention may include compliant electrodes that conform to the shape of an electroactive polymer to which they are attached. The electrodes may be only applied to a portion of an electroactive polymer and define an active area according to their geometry. Various types of electrodes suitable for use with the present invention include structured electrodes comprising metal traces and charge distribution layers, textured electrodes comprising varying out-of-plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present invention may vary. Suitable materials used in an electrode may include graphite, carbon black, colloidal suspensions, thin metals including silver and gold, silver-filled and carbon-filled gels and polymers, and ionically or electronically conductive polymers. It is understood that certain electrode materials may work well with particular polymers and may not work as well for others. By way of example, carbon fibrils may work well with acrylic elastomer polymers, but may not work as well with silicone polymers.

II. Exemplary Embodiments, Configurations, and Applications

An exemplary embodiment of the present invention is shown in FIG. 3, wherein the device 110 broadly comprises a wire 118 formed from an active material having an actuation temperature and a particular dimension, e.g., length and/or diameter, and the wire 118 being arranged to form a sleeve defining a volume of space into which the object 16 can be placed, wherein when the wire reaches the actuation temperature the dimension changes, which causes the volume of space to become smaller or larger around the object, thereby respectively clamping or releasing the object 16. The change in dimension may be reversible, depending on the particular active material used.

This implementation may further incorporate any one or more of the following additional features. As shown in FIG. 6, the wire 318 may be configured such that reaching the actuation temperature causes the volume of space to become smaller, or constrict around the object located within the space (again, compare FIG. 1 to FIG. 2). This may be accomplished by arranging the wire 318 in a spiral form with an angle that is at least approximately 55 degrees. As also shown in FIG. 6, the wire 319 may be configured such that reaching the actuation temperature causes the volume of space to become larger, or loosen around the object located within the space (now compare FIG. 2 to FIG. 1). This may be accomplished by arranging the wire 319 in a spiral form with an angle of less than approximately 55 degrees.

As mentioned, the preceding features may be combined, as shown in FIG. 6, wherein a first wire 318 having a first actuation temperature, and a second wire 319 having a second actuation temperature are arranged such that the wires 318,319 are separately actuatable to cause different changes to the volume of space. At least one of the first and second wires 318,319 may be configured such that reaching the actuation temperature causes the volume of space to become smaller. Additionally or alternatively, at least one of the first and second wires 318,319 may be configured such that reaching the actuation temperature causes the volume of space to become larger. The changes in one or both of the first and second dimensions may be reversible, depending on the active material used.

As shown in FIG. 3, the wire 118 may be covered by an external material 120, which may be an insulative or otherwise protective “covering” material. This may be accompanied by a biasing mechanism that may take the form of, for example, fluid pressure within the volume, an additional spiral wrap which is offset an equal amount in angle from the other side of 55 degrees, or being embedded within or proximate to an external or internal surface to an elastic layer. As also shown in FIG. 3, the device 110 may further comprise an intermediate “liner” material 122 which lines the volume of space, i.e., is interposed between the wire 118 and the object 16. The intermediate material 122 may be insulative or otherwise protective or may have the property of more evenly distributing forces acting on the object 16 resulting from the change in dimension of the wire 118 or may have the property of being the biasing mechanism which reverses the change in dimensions upon discontinuation of the actuation signal.

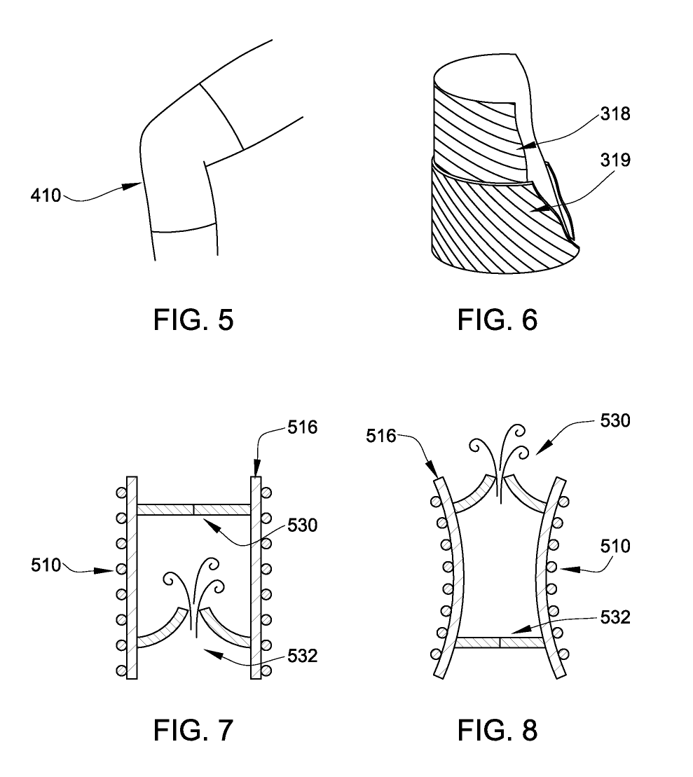

As shown in FIG. 5, one possible application of the device 410 is to support joints or other flexible connections on persons, animals, hoses, linkages, etc. One exemplary implementation might use the thermally-activated shape memory and stiffness changes in the active material to snug around and support the member(s). Another exemplary implementation might use the stress-activated shape memory effect in active material, i.e., superelasticity, to provide a self-adjusting member allowing greater freedom of movement while still maintaining support through changes in dimension of the constrained member.

As shown in FIGS. 7 and 8, another possible application of the device 510 is to pump fluid or gas through a system. The object may be a flexible conduit 516 having a first one-way valve 530 located downstream of a second one-way valve 532, and through which the fluid or gas travels. Referring particularly to FIG. 7, when the device 510 is in the first state, there is little or no force exerted on the conduit 516, the first one-way valve 530 is closed, the second one-way valve 532 is open, and a pressure differential causes the fluid or gas to flow into a space between the first and second valves 530,532. Referring particularly to FIG. 8, when the actuation temperature is reached and the device 510 changes to the second state, force is exerted on the flexible conduit 516 which deforms to exert a corresponding force on the fluid or gas within the space, this causes the first one-way valve 530 to open, the second one-way valve 532 to close, and the fluid to move through the first one-way valve 530 and out of the space. This results in the pressure differential that causes the second one-way valve 532 to open and the device 510 to return to the first state (of FIG. 7), and the pumping process can repeat.

Another possible application of the device 10 is as an external braking mechanism, wherein the object 16 located within the volume of space is moving linearly or rotationally, and the sleeve 12 is actuated to provide a clamping force on the object 16 that slows or stops its motion. The object 16 may be a rod or cable, and the sleeve 12 may be configured as a sheath through which the object 16 moves. The material 122 lining the sleeve 12 may be a friction material. Elastomer material may be interposed between the object 16 and the friction material 122.

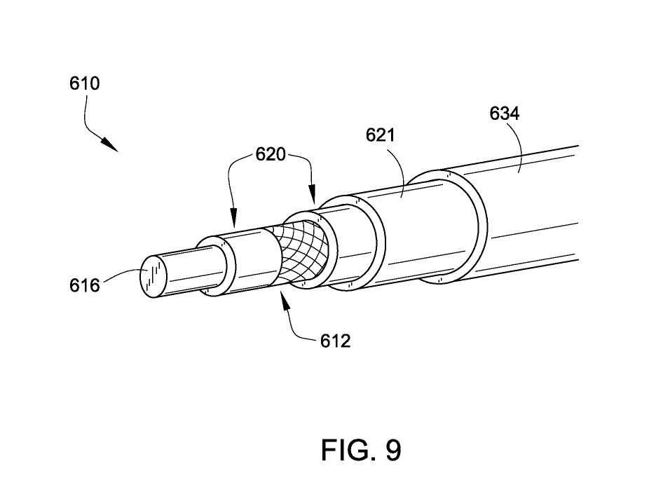

Referring to FIG. 9, another possible application of the device 10 is as an internal braking mechanism, wherein the sleeve 612 is normally contracted around the object 616 (which may be an armature), and the sleeve 612 and object 616 are stationary within or adjacent to a second structure 634 that is moving linearly or rotationally, and the sleeve 612 is actuated to relax and thereby contact the second structure 634 to slow or stop its motion. An elastomer material 620 may be interposed between the object 616 and the sleeve 612, and/or between the sleeve 612 and the second structure 634. Friction material 621 may be applied to the outer surface of the sleeve 612, the contact surface of the second structure 634, or the elastomer material 620 interposed therebetween. In one possible implementation, power is applied to the sleeve 612 while the second structure 634 is in motion, and when power is removed from the sleeve 612, the sleeve 612 relaxes and brakes the second structure 634.

Another possible application of the device 10 is as a gripping mechanism for cylindrical or other-shaped objects. The material 122 lining the sleeve 12 may be an elastomer material having any appropriate internal or external shape for receiving or otherwise engaging the object. The sleeve 12 and liner material 122 may be provided in lengths that can be trimmed to an appropriate size, and the sleeve 12 provided with electrical connections. In use, the sleeve 12 may be moved onto or into the object 16 and actuated to engage, or grip, the object 16 so that the object can be moved or otherwise manipulated.

Another possible application of the device 10 is as a control mechanism for controlling incremental fluid flow into or through the object 16 by clamping or releasing onto the object 16 or onto an opening into the object 16. In this manner, the device 10 might replace a conventional servo valve.

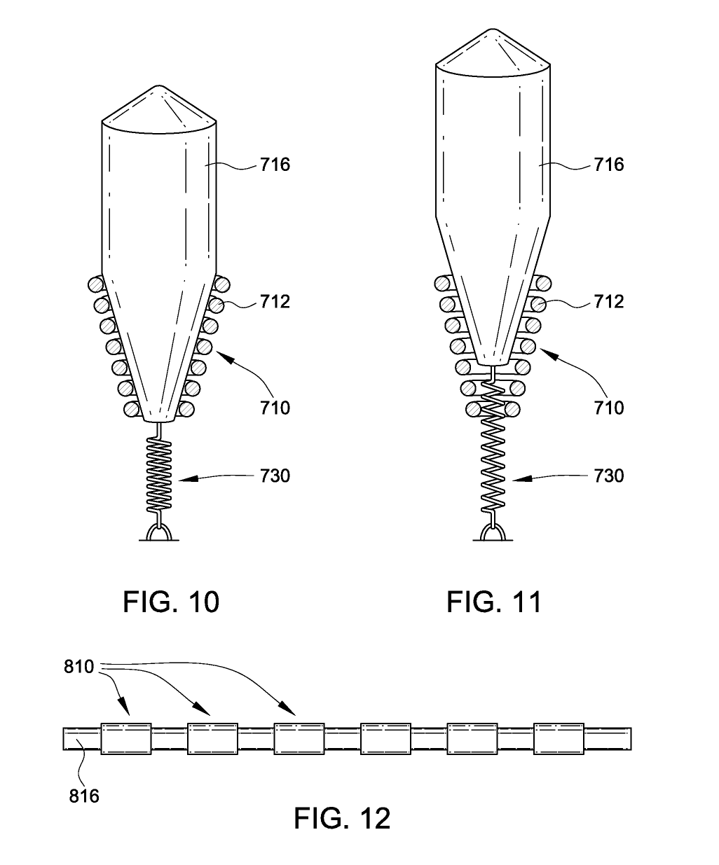

Referring to FIGS. 10 and 11, another possible application of the device 710 is as an actuating mechanism, wherein the object 716 is tapered, such that contraction of the sleeve 712, as seen in FIG. 11, moves the object 716 relative to the volume of space. The object 716 may be a pin, and may be biased, such as with a spring 730, so that it moves back to its original position when the sleeve 712 relaxes. In this manner, the device 710 might be used as a locking mechanism or pointer.

Referring to FIG. 12, another possible application of the device 10 is as a linear movement mechanism, wherein a series of the devices 810 are located on the elongated object 816, such that when the devices 810 are sequentially actuated the object 816 moves (if the devices 810 are stationary) or the devices 810 move (if the object 816 is stationary). In this manner, the series of devices 810 may be used to create a peristaltic wave.

Another possible application of the device 10 is as a bending mechanism, wherein at least one set of wires is configured linearly within the sleeve 12, such that actuation of the sleeve 12 causes it and the associated object 16 to bend in the direction of contraction.

It will be appreciated that the device of the present invention provides a number of advantages over prior art devices. For example, the device of the present invention readily conforms to objects with irregular shapes. Furthermore, the force applied by the device to an object located within the sleeve is relatively uniformly distributed around the object and over a relatively large surface area, which better avoids deforming or weakening the object. Additionally, the device is directly actuatable by any signal that warms or cools the device to the actuation temperature, without requiring a separate transducer. Additionally, the device is relatively small and lightweight, and relatively simple and inexpensive to manufacture, operate, and maintain.

The present invention has been described with reference to exemplary embodiments, configurations, and applications; it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment, configurations, or applications disclosed herein, but that the invention will include all embodiments, configurations, and applications falling within the scope of the appended claims. The terms “first,” “second,” and the like, as used herein do not denote any order, quantity, or importance, but rather are used to distinguish one element from another.

What is claimed is:

1. A device comprising:
an elongated piece of active material having an actuation temperature, and
the active material being arranged to form a sleeve defining a volume of space,
wherein when the active material reaches the actuation temperature the material changes, which causes one or more dimensions of the volume of space to change, such that an object located within the volume of space experiences a change in applied force.

2. The device as claimed in claim 1, wherein the active material is selected from the group consisting of: wires, cables, sheets, and strips.

3. The device as claimed in claim 2, wherein the active material has an arrangement being selected from the group consisting of: spirally wrapped, woven, braided, single layered, multilayered, looped, and banded.

4. A device comprising:
a wire,
the wire being formed from an active material having an actuation temperature and a dimension, and
the wire being arranged to form a sleeve defining a volume of space,
wherein when the wire reaches the actuation temperature the dimension of the wire changes, which causes one or more dimensions of the volume of space to change, such that an object located within the volume of space experiences a change in applied force.

5. The device as claimed in claim 4, wherein the wire is configured such that reaching the actuation temperature causes the volume of space to become smaller.

6. The device as claimed in claim 5, wherein the wire is arranged in a spiral form with an angle that is at least approximately 55 degrees.

7. The device as claimed in claim 4, wherein the wire is configured such that reaching the actuation temperature causes the volume of space to become larger.

8. The device as claimed in claim 7, wherein the wire is arranged in a spiral form with an angle of less than approximately 55 degrees.

9. The device as claimed in claim 4, wherein the change in dimension is reversible.

10. The device as claimed in claim 4, wherein the device further comprises an external material which covers the wire, wherein the external material is operable to increase friction between the device and an adjacent surface.

11. The device as claimed in claim 4, wherein the device further comprises an intermediate material which lines the volume of space.

12. The device as claimed in claim 11, wherein the intermediate material is operable to more evenly distribute the applied force.

13. The device as set forth in claim 11, wherein the intermediate material is operable to increase friction between the device and the object located within the volume of space.

14. The device as set forth in claim 4, wherein the volume of space is tapered, such that the change in applied force moves the object relative to the volume of space.

15. The device as set forth in claim 4, wherein the object is elongated, and a plurality of the devices are serially arranged upon the elongated object and configured to be sequentially actuated.

16. The device as set forth in claim 4, wherein the object is a flexible conduit having a first one-way valve spaced apart from a second one-way valve, and the change in applied force acts to pump a fluid or gas through the first and second one-way valves.

17. The device as claimed in claim 4, wherein—
the wire is arranged in a spiral form with a first angle,
the device further comprising—
a second wire formed from an active material and having a second actuation temperature and a second angle, such that the wire and the second wire are separately actuatable to cause a different change to the volume of space.

18. A device comprising:
a first wire formed from an active material having a first actuation temperature and a first dimension, and
the first wire being arranged to form a sleeve defining a volume of space, and
wherein when the first wire reaches the actuation temperature the first dimension changes, which applies a first force to an object located within the volume of space; and
a second wire formed from an active material having a second actuation temperature and a second dimension, and
the second wire being arranged to form a sleeve further defining the volume of space,
wherein when the second wire reaches the actuation temperature the second dimension changes, which applies a second force to the object located within the volume of space.

19. The device as claimed in claim 18, wherein at least one of the first and second wires is arranged in a spiral form with an angle that is at least approximately 55 degrees.

20. The device as claimed in claim 18, wherein at least one of the first and second wires is arranged in a spiral form with an angle of less than approximately 55 degrees.
